(19) United States
(12) Patent Application Publication
(10) Pub. No.: US 2018/0222167 A1
(43) Pub. Date: Aug. 9, 2018

(54) SHAFT-LIKE COMPOSITE MEMBER

(71) Applicant: HONDA MOTOR CO., LTD., Tokyo (JP)

(72) Inventors: Nobuhiro YAMADA, Wako-shi (JP); Kazuhiro TANEDA, Wako-shi (JP); Hiroshi KIYOMOTO, Wako-shi (JP); Seijiro MASAKI, Wako-shi (JP); Atsushi YOKOYAMA, Wako-shi (JP)

(21) Appl. No.: 15/890,657

(22) Filed: Feb. 7, 2018

(30) Foreign Application Priority Data
Feb. 8, 2017 (JP) 2017-021378

(51) Int. Cl. B32B 27/20; B32B 27/08; B32B 1/08; B29C 70/34

(52) U.S. Cl. CPC B32B 27/20; B32B 27/08; B32B 1/08; B29K 2307/04; B32B 2262/101; B32B 2262/106; B29C 70/342

(57) ABSTRACT

A shaft-like composite member made by laminating the 0 degree layer which is a base layer wherein an alignment direction of a carbon fiber (long fiber) is parallel to an axis of the shaft-like composite member; the +/−45 degrees layer which is placed on the inner diameter side of the 0 degree layer wherein an alignment direction of a carbon fiber (long fiber) is oblique to the axis of the shaft-like composite member; an inner glass fiber reinforced plastic layer which is interposed between the 0 degree layer on the outer diameter side and the +/−45 degrees layer on the inner diameter side so as to serve as a stress relaxation layer; and the outer glass fiber reinforced plastic layer which is placed on the outer diameter side of the 0 degree layer is provided.

### TECHNICAL FIELD

The present invention relates to a shaft-like composite member.

### BACKGROUND ART

In recent years, a motor vehicle is required to use light weight and high strength materials in order to enhance its fuel consumption performance. For example, fiber reinforced resins such as carbon materials are used. For example, as an example to use the fiber reinforced resin, Patent Literature 1 discloses a technical idea of winding a carbon fiber reinforced layer (fiber reinforced layer) on an outer surface of a carbon fiber reinforced aluminum pipe (metal shaft-like member) by using a rolling table.

In addition, Patent Literature 2 discloses a shaft for a golf club made of a fiber reinforced composite material formed by laminating pluralities of carbon fibers having different alignment angles respectively from inside toward outside.

### PRIOR ART DOCUMENTS

Patent Literature 1: JP H03-0166937 A

Patent Literature 2: JP 2007-0000528 A

### SUMMARY OF THE INVENTION

By the way, for example, when a fiber reinforced resin material is applied to a shaft-like composite member having high curvature configuration such as a curved portion (e.g., the shaft-like composite member applied to a frame structure body of a motor vehicle), it is difficult to wind a fiber reinforced resin material on this curved portion and to keep a stiffness of the frame structure body. For example, when a carbon fiber reinforced layer disclosed in Patent Literature 1 is wound on a linear core metal and the core metal is bent at a predetermined large curvature, wrinkling may occur on the carbon fiber reinforced layer wound on an inner side of the curved portion due to a difference between an inside circumference length and an outside circumference length of the curved portion.

For this reason, in order to prevent the wrinkling from occurring on the inner side of the curved portion, UD materials (unidirectional reinforced materials) made of a carbon fiber reinforced plastic (CFRP) may be provided parallel to an axis of the shaft-like composite member (i.e., a 0 degree layer) so that the difference between the inside circumference length and the outside circumference length of the curved portion is canceled. However, when a torsional deformation force (a torsional load) is applied to the curved portion in which the UD materials are provided in parallel, a surface external force is applied to the curved portion in an outer diameter direction and the 0 degree layer on a surface layer is deformed in the outer diameter direction. As the result, the above structure may be a weak point in strength of the curved portion.

The present invention has been made in view of the above; it is an object to provide a shaft-like composite member which enables to keep a desired strength at a curved portion.

In order to achieve the above object, the present invention provides a shaft-like composite member, wherein the shaft-like composite member includes a linear portion; and a curved portion, and the curved portion includes a 0 degree layer which is made of a carbon fiber reinforced plastic, and an alignment direction of the carbon fiber is parallel to an axis of the shaft-like composite member; and a glass fiber reinforced plastic layer which is placed on an outer surface of the 0 degree layer, and a stiffness thereof is lower than that of the carbon fiber reinforced plastic.

The present invention can provide a shaft-like composite member which enables to keep a desired strength at a curved portion.

### BRIEF DESCRIPTION OF DRAWINGS

FIG. 1 is a perspective view of a shaft-like composite member of an embodiment according to the present invention;

FIG. 2 is a cross sectional view taken along the line II-II of FIG. 1;

FIGS. 3A-3G are schematic diagrams showing a manufacturing process for manufacturing the shaft-like composite member according to this embodiment; and

FIG. 4 is an explanatory diagram comparing durability of a shaft-like composite member according to a compared example having no reinforcing layer and that of a shaft-like composite member according to this embodiment having a reinforcing layer.

### BEST MODE FOR CARRYING OUT THE PRESENT INVENTION

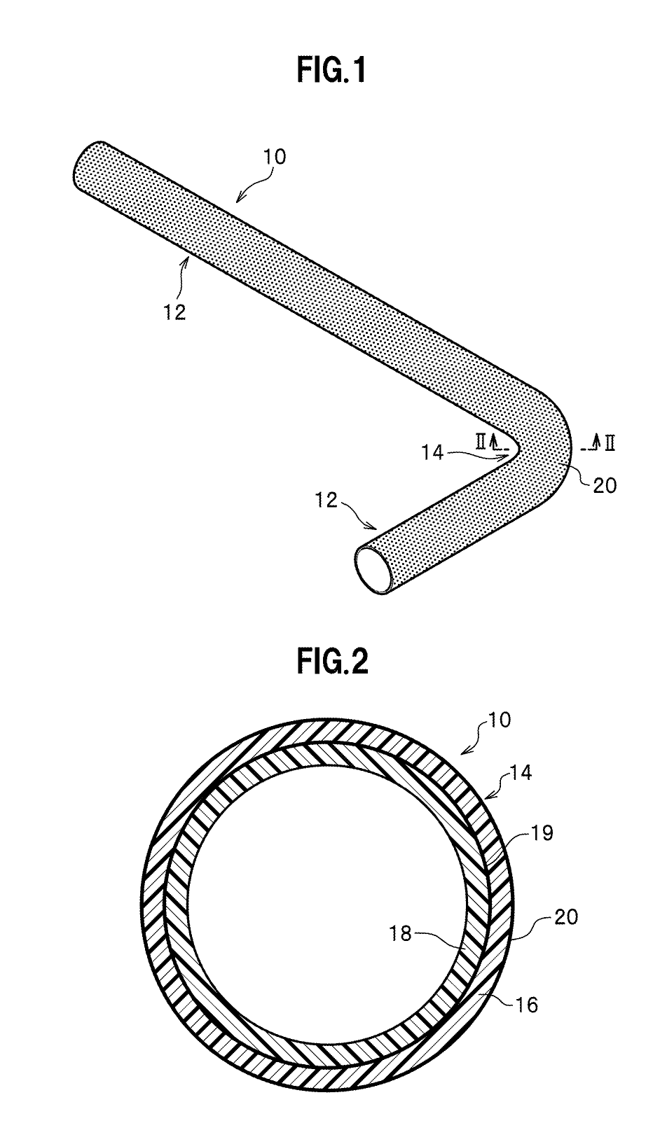

Next, referring to FIGS. 1-4, embodiments of the present invention will be explained.

FIG. 1 is a perspective view of a shaft-like composite member of an embodiment according to the present invention; and FIG. 2 is a cross sectional view taken along the line II-II of FIG. 1.

For example, a shaft-like composite member 10 according to this embodiment can be used as a part of a vehicle, a steering handle, a suspension tower bar, a suspension arm, and a stabilizer. Also, the shaft-like composite member 10 can be used as sports and leisure goods, a bicycle handlebar, and a part of a baby baggy, etc.

As shown in FIG. 1, the shaft-like composite member 10 is made of an L-shaped hollow tube including linear portions 12 and a non-linear curved portion 14.

The shaft-like composite member 10 (i.e., the linear portions 12, and the curved portion 14) is made by laminating four layers in a radial direction. These four layers are successively formed along a circumferential direction respectively. As shown in FIG. 2, the shaft-like composite member 10 is made by sequentially laminating a +/−45 degrees layer 18, an inner glass fiber reinforced plastic layer 19, a 0 degree layer 16, and a outer glass fiber reinforced plastic layer 20 from an inner diameter side to an outer diameter side respectively.

In more detail, the shaft-like composite member 10 is made by laminating the 0 degree layer 16 which is a base layer wherein an alignment direction of a carbon fiber (long fiber) is parallel to an axis of the shaft-like composite member 10; the +/−45 degrees layer 18 which is placed on the inner diameter side of the 0 degree layer 16 wherein an alignment direction of a carbon fiber (long fiber) is oblique to the axis of the shaft-like composite member 10; an inner glass fiber reinforced plastic layer 19 which is interposed between the 0 degree layer 16 on the outer diameter side and the +/−45 degrees layer 18 on the inner diameter side so as to serve as a stress relaxation layer; and the outer glass fiber reinforced plastic layer 20 which is placed on the outer diameter side of the 0 degree layer 16. In addition, as described below, the outer glass fiber reinforced plastic layer 20 serves as a reinforcing layer and a protection layer.

The 0 degree layer 16 is made of an UD (Uni-Directional) member whose alignment direction of fibers is parallel to the axis of the shaft-like composite member 10. The UD material is a carbon fiber reinforced plastic (CFRP).

The +/−45 degrees layer 18 is made of a prepreg (e.g., a tow-prepreg) whose alignment direction of a carbon fiber is oblique to the axis of the shaft-like composite member 10. The tow-prepreg is made of a large number of filaments which are made of a carbon fiber (i.e., a reinforcing member) impregnated with a resin (i.e., a matrix material). For example, thermosetting resins such as an epoxy resin, an unsaturated polyester resin, a polyurethane resin, a diallyl phthalate resin, a phenol resin, and a polyimide resin, etc. can be used as the resin.

The inner glass fiber reinforced plastic layer 19 and the outer glass fiber reinforced plastic layer 20 are made of a prepreg. The prepreg is made of a glass fiber reinforced plastic (GFRP). The 0 degree layer 16 is made of a carbon fiber reinforced plastic (CFRP). A stiffness of the glass fiber reinforced plastic (GFRP) is lower than that of the carbon fiber reinforced plastic (CFRP). Using this glass fiber reinforced plastic (GFRP), chopped glass fiber layers (short fiber) are formed between the 0 degree layer 16 and the +/−45 degrees layer 18, and between the 0 degree layer 16 and the outer surface. A stiffness of the chopped glass fiber layer (short fiber) is lower than those of the 0 degree layer 16 and the +/−45 degrees layer 18. In addition, the inner glass fiber reinforced plastic layer 19 and the outer glass fiber reinforced plastic layer 20 are not limited to the short fiber (the chopped glass fiber layer). A long fiber whose stiffness is lower than those of the 0 degree layer 16 and the +/−45 degrees layer 18 can be used.

As shown in FIG. 2, in the radial direction, a thickness of the 0 degree layer 16 is almost the same as that of the +/−45 degrees layer 18, and a thickness of the inner glass fiber reinforced plastic layer 19 and a thickness of the outer glass fiber reinforced plastic layer 20 are smaller than those of the 0 degree layer 16 and the +/−45 degrees layer 18. Also, the thickness of the inner glass fiber reinforced plastic layer 19 is almost the same as that of the outer glass fiber reinforced plastic layer 20.

In this embodiment, the shaft-like composite member 10 (i.e., the linear portion 12, and the curved portion 14) is formed of a four layer structure which is made by sequentially laminating the +/−45 degrees layer 18, the inner glass fiber reinforced plastic layer 19, the 0 degree layer 16, and the outer glass fiber reinforced plastic layer 20 from the inner diameter side to the outer diameter side. However, the structure is not limited to the above.

That is, the shaft-like composite member 10 may be formed of a four layer structure in which at least the curved portion 14 includes the outer glass fiber reinforced plastic layer 20. Also, the linear portion 12 may be formed of a three layer structure which includes the 0 degree layer 16, the inner glass fiber reinforced plastic layer 19, and the +/−45 degrees layer 18 other than the outer glass fiber reinforced plastic layer 20. Further, the linear portion 12 may be formed of a two layer structure which includes the 0 degree layer 16 and the +/−45 degrees layer 18.

For example, in the shaft-like composite member 10 of this embodiment, the 0 degree layer 16 placed at the outer diameter side has a stiffness (a high bending stiffness) to a bending load applied to the curved portion 14, and the +/−45 degrees layer 18 placed at the inner diameter side has a stiffness (a high torsional stiffness) to a torsional load. At that time, the layers in the curved portion 14 are deformed different from each other since each layer has a different stiffness. At that time, a surface external force is applied to the 0 degree layer 16 at an outer surface side of the curved portion 14 in the outer diameter direction, and the portion applied to the surface external force may be a weak point in strength.

For this reason, in this embodiment, an outer glass fiber reinforced plastic layer 20 whose bending stiffness is lower than that of the 0 degree layer 16 and whose torsional stiffness is lower than that of the +/−45 degrees layer 18 is provided on an outer surface of the 0 degree layer 16. With respect to this point, explanation will be made below.

Next, a manufacturing process for manufacturing the shaft-like composite member 10 will be explained.

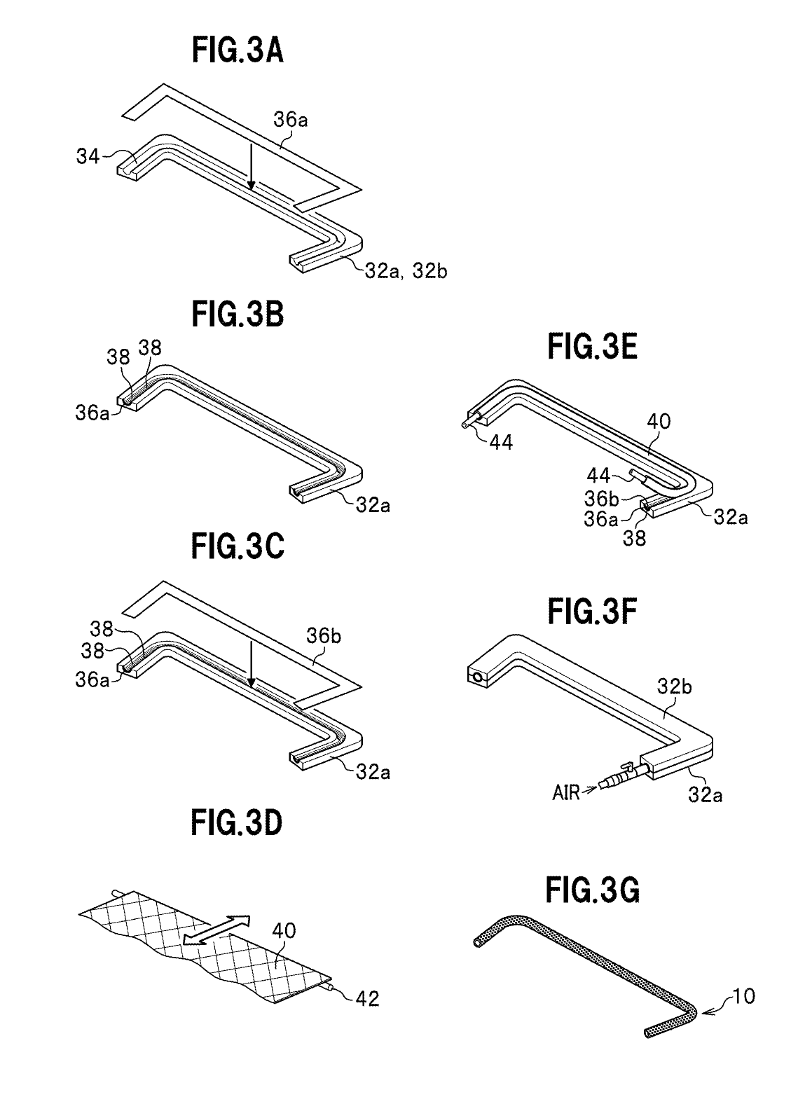

FIGS. 3A-3G are schematic diagrams showing a manufacturing process for manufacturing the shaft-like composite member according to this embodiment.

A pair of metal molds 32a, 32b are prepared (see FIG. 3F). The metal molds 32a, 32b is provided with a cavity 34 (see FIG. 3A). The cavity 34 is a groove whose cross section has a semicircular shape, and is L-shaped in a top surface view corresponding to a shape of the shaft-like composite member 10. In addition, the shape of the groove of the metal mold 32a is symmetrical to that of the metal mold 32b.

First, a prepreg sheet 36a (i.e., an outer glass fiber reinforced plastic material) made of the glass fiber reinforced plastic (GFRP) is laid in the cavity 34 of the metal mold 32a (32b) (see FIG. 3A).

Next, pluralities of UD materials 38 which serve as the 0 degree layer are laid on the prepreg sheet 36a along an axis of the cavity 34 (see FIG. 3B). Next, a prepreg sheet 36b (i.e., an inner glass fiber reinforced plastic material) made of the glass fiber reinforced plastic (GFRP) is laid on the UD materials 38 so that a laminate body is formed in the cavity 34 (see FIG. 3C).

In addition, the prepreg sheet 36b (i.e., the inner glass fiber reinforced plastic material) and a prepreg sheet 40 (i.e., a +/−45 degrees material) described below may be wound to be molded by a sheet winding method.

Also, the prepreg sheet 40 (e.g., a tow-prepreg) (i.e., +/−45 degrees material) is wound on an outer surface of a resin mandrel (i.e., a core metal) 42 using a jig (not shown) by the sheet winding method (see FIG. 3D). This prepreg sheet 40 is a thin sheet which is made of a carbon fiber impregnated with a resin. The thin sheet is made by weaving a +45 degrees carbon fiber and a −45 degrees carbon fiber. After removing the resin mandrel (the core metal) 42 from the wound prepreg sheet 40, for example, a rubber tube bag (an inner pressure bag) 44 is inserted instead of the resin mandrel 42.

In this embodiment, the prepreg sheet (i.e., the +/−45 degrees material) is wound by the sheet winding method. However, the filament may be wound by, for example, a filament winding method.

Next, the wound prepreg sheet 40 (i.e., +/−45 degrees material) is laid on the laminate body (i.e., the outer glass fiber reinforced plastic material, the UD material, and the inner glass fiber reinforced plastic material) formed in the metal mold 32a (see FIG. 3E), and the pair of metal molds 32a, 32b are closed. After closing the pair of metal molds 32a, 32b, plug members (not shown) are attached to both ends of the tube bag 44. For example, air at approximately 0.6 MPa is supplied to the tube bag 44 from an air source (not shown) (see FIG. 3F).

Further, the resin is hardened by heat by performing heat treatment at a predetermined temperature using a heating unit (not shown), the pair of metal molds 32a, 32b are parted, and the molded shaft-like composite member 10 is extracted (see FIG. 3G).

By conducting the above manufacturing process, the shaft-like composite member 10 including the +/−45 degrees layer 18 placed at the inner diameter side; the UD material 38 (i.e., the 0 degree layer 16) placed at the outer diameter side; the inner glass fiber reinforced plastic layer 19 (GFRP) which is interposed between the +/−45 degrees layer 18 and the 0 degree layer 16; and the outer glass fiber reinforced plastic layer 20 (GFRP) which is placed on the outer diameter side of the 0 degree layer 16 can be obtained easily. Also, in this manufacturing process, by using the pair of metal molds 32a, 32b, the difference between an inside circumference length and an outside circumference length of the curved portion 14 is absorbed, the wrinkling is prevented from occurring, and a strength of the curved portion 14 can be enhanced.

Next, advantageous effects of the shaft-like composite member 10 according to this embodiment will be explained.

In this embodiment, the outer glass fiber reinforced plastic layer 20 whose bending stiffness is lower than that of the 0 degree layer 16 and whose torsional stiffness is lower than that of the +/−45 degrees layer 18 is provided on the outer surface of the 0 degree layer 16. In this way, in this embodiment, when a bending load and a torsional load is applied to the curved portion 14, a surface external force in the outer diameter direction is prevented from being applied to the outer surface of the 0 degree layer 16, and a strength (especially, a fatigue strength) of the outer surface can be enhanced. As the result, in this embodiment, a desired strength of the curved portion 14 can be kept, and durability can be enhanced.

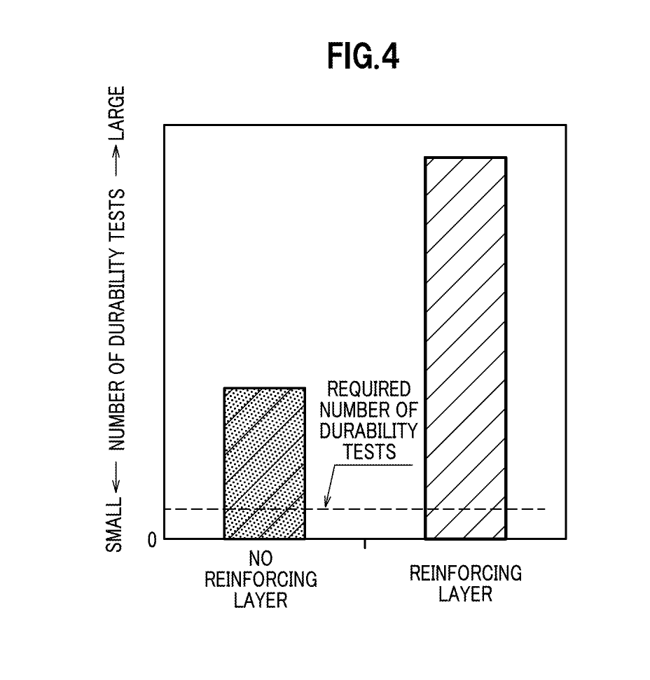

FIG. 4 is an explanatory diagram comparing durability of a shaft-like composite member according to a compared example having no reinforcing layer and that of a shaft-like composite member according to this embodiment having a reinforcing layer.

As shown in FIG. 4, comparing number of durability tests between a shaft-like composite member according to a compared example having no outer glass fiber reinforced plastic layer 20 (no reinforcing layer) and a shaft-like composite member 10 according to this embodiment having the outer glass fiber reinforced plastic layer 20 (the reinforcing layer), 2.5 times of durability is achieved.

Also, in this embodiment, the fatigue strength can be enhanced while keeping the stiffness since the outer glass fiber reinforced plastic layer 20 (the reinforcing layer) has no function to enhance the stiffness.

Further, in this embodiment, the shaft-like composite member 10 can enhance its strength while preventing an increase in weight since main layers (i.e., the 0 degree layer 16, and the +/−45 degrees layer 18) can suppress surface external force while preventing its thickness from increasing.

Still further, in this embodiment, a color of the outer glass fiber reinforced plastic layer 20 becomes white when a crack occurs on the 0 degree layer 16. In this way, damage to the curved portion 14 can be visible easily. As the result, high maintainability is achieved, and a replacement time of the shaft-like composite member 10 can be predicted easily.

In general, in a fiber reinforced plastic pipe (the shaft-like composite member 10) to which pluralities of loads (e.g., the bending load, and the torsional load, etc.) are applied, it is desired that pluralities of layers having different alignment angles support different loads. However, due to demand about manufacturing process, the 0 degree layer 16 which is durable to the bending load is assigned to the outer surface.

In this structure, the layers are deformed different from each other since each layer has a different stiffness (e.g., the bending stiffness, and the torsional stiffness, etc.). At that time, a surface external force is applied to the 0 degree layer 16 at an outer surface side in the outer diameter direction, and the portion applied to the surface external force may be a weak point in strength.

In this embodiment, in order to solve the above problem, a reinforcing layer (the outer glass fiber reinforced plastic layer 20) whose bending stiffness is lower than that of the 0 degree layer 16 and whose torsional stiffness is lower than that of the +/−45 degrees layer 18 is provided on an outer surface of the 0 degree layer 16. In this way, the deformation can be suppressed, and the strength (especially, the fatigue strength) can be enhanced.

Further, the outer glass fiber reinforced plastic layer 20 at the outer surface side tends to be applied a large stress due to a large distance from a center of the shaft-like composite member 10. By forming a layer which has a low stiffness enough to suppress the deformation, the stress applied to the reinforcing layer (the outer glass fiber reinforced plastic layer 20) is reduced. As the result, the reinforcing layer can perform its function without being deformed earlier than other layers (e.g., the 0 degree layer 16, and the +/−45 degrees layer 18) being deformed.

Still further, in general, the thickness is increased at the cost of weight in order to enhance the strength. However, in this embodiment, the strength can be enhanced with little increase in the weight and no increase in the stiffness. In this way, for example, the lightweight can be achieved, and a product having target stiffness can be manufactured effectively.

Still further, the reinforcing layer (the outer glass fiber reinforced plastic layer 20) serves as a protection layer to chipping. Also, a color of the reinforcing layer (the outer glass fiber reinforced plastic layer 20) becomes white when a crack occurs on the 0 degree layer 16. In this way, damage can be visible easily.

What is claimed is:

1. A shaft-like composite member, wherein
the shaft-like composite member comprises:
a linear portion; and
a curved portion, and
the curved portion comprises:
a 0 degree layer which is made of a carbon fiber reinforced plastic, and an alignment direction of the carbon fiber is parallel to an axis of the shaft-like composite member; and
a glass fiber reinforced plastic layer which is placed on an outer surface of the 0 degree layer, and a stiffness thereof is lower than that of the carbon fiber reinforced plastic.

2. The shaft-like composite member according to claim 1,
wherein the curved portion is a part of a stabilizer.
